(19) United States
(12) Patent Application Publication
(10) Pub. No.: US 2026/0070052 A1
(43) Pub. Date: Mar. 12, 2026

(54) PIPETTE TIP HAVING A RECEIVING SPACE THAT TAPERS IN A CURVED MANNER

(71) Applicant: Hamilton Bonaduz AG, Bonaduz (CH)

(72) Inventors: Hanspeter Romer, Hinwil (CH); Jonas Hilti, Balzers (LI); Mathias Nagel, Bern (CH); Adrian Rohner, Uerikon (CH)

(21) Appl. No.: 19/102,019

(22) PCT Filed: Aug. 7, 2023
(86) PCT No.: PCT/EP2023/071779

§ 371 Date: Feb. 7, 2025

(30) Foreign Application Priority Data
Aug. 10, 2022 (DE) 10 2022 120 212.7

(51) Int. Cl. B01L 3/02

(52) U.S. Cl. CPC B01L 3/0275

(57) ABSTRACT

An exchangeable pipette tip, wherein the pipette tip extends along a channel axis, wherein the channel axis defines an axial direction running along the channel axis, radial directions orthogonal with respect to the channel axis, and a circumferential direction encircling the channel axis, wherein the pipette tip, at one axial longitudinal end thereof forming a coupling longitudinal end, has a coupling formation which is designed for coupling to a counterpart coupling formation of a pipette device, wherein the pipette tip, at the longitudinal end thereof situated axially opposite the coupling longitudinal end and forming a dosing longitudinal end, has a pipette opening that is communicatively connected to a receiving space designed for receiving liquid that is to be dosed, wherein the receiving space of the pipette tip is designed to taper toward the pipette opening, wherein at least one axial portion of the receiving space is concave and forms a concave axial portion, such that an inner wall of the pipette tip that radially delimits the portion is curved about at least one curvature axis running transversely with respect to the channel axis.

This application claims priority in PCT application PCT/EP2023/071779 filed Aug. 7, 2023, which claims priority in German Patent Application DE 10 2022 120 212.7 filed on Aug. 10, 2022, which are incorporated by reference herein.

The present invention concerns an exchangeable pipette tip for pipetting devices, in particular for pipetting robots. The pipette tip extends along a duct axis.

The duct axis defines an axial direction running along the duct axis, radial directions orthogonal to the duct axis, and a circumferential direction encircling the duct axis.

The pipette tip exhibits at its one axial longitudinal end, referred to below as ‘coupling longitudinal end’, a coupling formation configured for coupling with a coupling counter-formation of a pipetting device.

At its longitudinal end which is axially opposite to the coupling longitudinal end and which is referred to below as ‘metering longitudinal end’, the pipette tip exhibits a pipetting aperture which is connected in a communicating manner with a receiving space configured for receiving fluid which is to be metered. Through the pipetting aperture, fluid can thus enter from the external environment of the pipette tip into the receiving space and from the receiving space into the external environment.

The receiving space of the pipette tip is configured as tapering toward the pipetting aperture.

### BACKGROUND OF THE INVENTION

Such pipette tips are sufficiently known in the state of the art. They are used, for example, by the applicant under the trade name ‘CO-RER’. These are, as also in the preferred embodiments of the present invention, synthetic components made in the injection molding process. Such pipette tips are single-use pipette tips, which for reasons of hygiene are disposed of after single use in order to avoid cross-contamination. Therefore the exchangeable pipette tips are couplable temporarily with a pipetting device for a pipetting operation. The coupling formation of the pipette tip allows coupling of the pipette tip with and subsequently disengagement of the same from a coupling counter-formation of a pipetting device.

The trade name ‘CO-RER’ is an acronym for the expression ‘Compressed O-Ring Expansion’, which indicates the type of a latching of the pipette tip onto a pipetting device through axial compression and thereby effected radial expansion of an O-ring. The O-ring which is deformable in the mentioned manner is arranged at the coupling counter-formation of the pipetting device and can through radial expansion engage with a concave latching recess configured in the coupling formation and encircling the duct axis. Thereby the O-ring can not only hold the pipette tip positively at the coupling counter-formation, but also at the same time seal the coupling formation gas-tight against the external environment.

The concave latching recess, like the O-ring engaging with it through deformation, configured rotation-symmetrically with respect to the duct axis in order to achieve the described sealing effect and forms along an axial region of the coupling formation a recess in the inside wall which indents the inside wall of the coupling formation radially outward.

Such a pipette tip is know for example from EP 1 171 240 A1.

A further development of this pipette tip is known from WOXXX 2017/218032 A1. In this further development, the O-ring latching the pipette tip to the coupling counter-formation is replaced at the coupling counter-formation of the pipetting device by a segmented spring collar with convex projections protruding radially outward. The convex projections can be displaced against their spring pre-tensioning radially outward through an axially displaceable clamping cone into engagement with the still present latching recess in the coupling formation of the pipette tip, thus holding the pipette tip securely to the coupling counter-formation of the pipetting device. Because of the segmenting of the convex projections, however, the sealing effect provided by the O-ring does not apply. The further development of the pipette tip, therefore, exhibits at an axial distance from the latching recess a normally conical, more precisely: negatively conical, separate abutment surface for a seal arranged at the coupling counter-formation for sealing the coupled pipette tip against the external environment.

The advantage of this construction lies inter alia in that the seal and/or abutment surface for the seal as the case may be lying axially nearer to the metering longitudinal end also shields the convex projections protruding radially outward against contamination by metering fluid. Furthermore, the seal envisaged at the coupling counter-formation can be deformed solely through the coupling movement of the pipette tip and/or its coupling formation as the case may be relative to the coupling counter-formation and unlike the aforementioned O-ring requires no deformation actuator.

The pipette tips of the present application are suitable and designed for metering of fluid in a pipetting operation in which in a pipetting duct of a pipetting device coupled with the pipette tip there is present a working gas whose pressure is manipulated relative to the ambient pressure by the pipetting device, in order thereby to aspirate fluid which is to be metered into the receiving space of the pipette tip and dispense it out of the receiving space of the pipette tip. During a pipetting operation there is normally also working gas constantly present in the pipette tip, since the latter normally is not completely filled with fluid which is to be metered (referred to hereunder as ‘metering fluid’). Due to gravity, the metering fluid received into the pipette tip is situated in the pipetting operation nearer to the pipetting aperture, the working gas which transmits pressure changes to the metering fluid normally takes up a volume which axially lies further away from the pipetting aperture than the received metering fluid. That is, the pipette tip coupled to a pipetting device lengthens for the duration of the coupling the pipetting duct of the pipetting device allocated through coupling.

Dispensing is always a task of a pipette tip as discussed here. Aspiration is a preferred manner of receiving metering fluid into the receiving space. That notwithstanding, the receiving space can also be filled with metering fluid from the side of the pipetting device through filling ducts.

Manufacturers and users of pipette tip are always anxious both to increase the accuracy of a pipetting process, in particular of dispensing, and also to decrease the minimum possible repeatable dispensable fluid quantity. Often, the pipette tips discussed here are used on pipetting robots for screening with very expensive fluids which often are available only in very small quantities. The smaller the quantities of such valuable fluids which can be repeatably dispensed, the more economically can the screening process be performed, to mention only one possible visualization example.

Limits to the accuracy of dispensing and to the minimum possible repeatable dispensable fluid quantity are set by effects of wetting of surfaces of the pipette tip by the metering fluid and by any squirts that may form during dispensing. The effect of squirts is that the actually metered quantity is no longer released as a single fluid drop but as a fluid drop with satellite drops.

With the pipette tips discussed in the present application it is possible to dispense quasi-synchronously through displacement of working gas and it is possible to dispense asynchronously through momentum transfer. In the quasi-synchronous method through the displacement of working gas, the dispensed fluid quantity essentially follows the temporally the movement of a pipetting piston of the pipetting device, which is displaced towards the pipetting aperture for displacing working gas in its pipetting duct under an increase in the pressure of the working gas. The movement of the pipetting piston and of the metering fluid through the pipetting aperture of the pipette tip takes place at the same time and in the same direction. The pipetting piston displaces working gas, which in turn displaces metering fluid which has been received in the receiving space. The working gas volume displaced during the piston movement usually corresponds approximately to the dispensed fluid quantity.

In the asynchronous method through momentum transfer, the movement of a pipetting piston and the thereby effected dispensing of a fluid drop do not take place at the same time and in the same direction, whereby due to the method the dispensing always follows a piston movement performed in the dispensing direction. The metering fluid goes through the pipetting aperture either while the pipetting piston moves in the aspiration direction or when the pipetting piston is stationary. In addition, the volume traversed during the piston movement by a pipetting piston area wetted by the working gas is not in a direct ratio to the dispensed fluid quantity. Rather, the pipetting piston is moved at a very high acceleration in a short time in the dispensing direction and subsequently in the aspiration direction in order to create in the working gas a pressure pulse which propagates in the working gas along the duct axis and finally impinges on the metering fluid surface in the receiving space which faces towards the working gas. According to a theory currently in use, the pressure pulse transmitted by the working gas to the metering fluid propagates in the metering fluid further along the duct axis in the direction towards the pipetting aperture and leads at the meniscus of the metering fluid received in the pipette tip lying nearer to the pipetting aperture to the detaching of a fluid droplet.

The movement of a pipetting piston is only one, albeit the most widely prevalent, possibility of a pressure change in the working gas. Equally, a pressure reservoir can be used which via at least one valve arrangement can be connected temporarily in a communicating manner with the working gas in the pipetting duct and separated again.

With a displacement-based dispensing method, fluid drops can be dispensed repeatably down to the single-figure microliter range. With a pulse-based dispensing method, fluid drops of less than 1 μl can be dispensed with sufficient repeat accuracy.

### SUMMARY OF THE INVENTION

It is, therefore, the task of the present invention to improve the exchangeable pipette tips known from the state of the art in such a way that they can pipette the smallest possible fluid quantities in the single-figure microliter range or below with higher accuracy.

The present application uses the term ‘pipetting’ as an umbrella term for the aspiration of fluid through the pipetting aperture into the receiving space of the pipette tip and for the dispensing of fluid out of the receiving space of the pipette tip through its pipetting aperture.

The present invention solves the mentioned task by having at least one axial section of the receiving space configured concavely as a concave axial section in such a way that an inside wall of the pipette tip bordering it radially is configured curved about at least one axis of curvature running transversely to the duct axis.

The known state of the art pipette tips normally exhibit a conical receiving space, where the receiving space can exhibit along the duct axis more than one cone angle. For example, the conical receiving space of the aforementioned pipette tips of the CO-RER type exhibits in a section which comes out from the pipetting aperture and contains the latter a first smaller cone angle and exhibits in a second section connected axially to the first section axial a greater cone angle. Through the conical configuration of the receiving space, the inside wall bordering it radially is configured concavely around the duct axis as axis of curvature. The inside wall of the known pipette tip does not, however, exhibit a further curvature.

Experiments and computer-aided simulations of the applicant have now shown that through at least section-wise abandonment of the conical shape of the receiving space in favor of a receiving space whose inside wall is curved about at least one axis of curvature running transversely to the duct axis, considerable accuracy advantages can be achieved during dispensing. This applies first and foremost to pulse-based dispensing which is preferred for smaller fluid quantities.

Without wishing to restrict oneself to the theory expressed hereunder, the described concave configuration of the receiving space seems to influence advantageously the propagation in the metering fluid towards the pipetting aperture of the pressure pulse induced by the working gas in the metering fluid, compared with the conical receiving space used thus far.

The concave configuration of the receiving space in the concave axial section is preferably established through an inside wall of the pipette tip which is curved along the duct axis step- and kink-free and borders the receiving space radially outward. However, it should not be ruled out that the concave configuration of the receiving space in the concave axial section is formed by an axial polyhedric sequence of inside wall areas, of which each inside wall area exhibits no curvature about an axis of curvature running transversely to the duct axis, but which overall lead to a concave configuration of the inside wall about an axis of curvature running transversely to the duct axis. Thus for example, an appropriately concavely curved receiving space can be achieved in the concave axial section through an axial sequence of coaxial negatively conical inside wall sections, of which the negatively conical section following in the direction towards the pipetting aperture of the pipette tip exhibits a cone opening angle greater in magnitude than an axially immediately preceding conical section which lies further away from the pipetting aperture.

When the pipette tip, as preferred by the present invention, exhibits a rotation-symmetrical inside wall for radial bordering of the receiving space, the receiving space exhibits infinitely many axes of curvature running transversely to the duct axis, about which the inside wall is locally curved. The inside wall can then be conceived as formed through the rotation of a generating curve about the duct axis. The generating curve is curved about at least one axis of curvature running transversely to the duct axis. With the rotation of the generating curve about the duct axis, there rotates also the at least one axis of curvature of the generatrix about the duct axis, which as result leads to the infinitely large number of axes of curvature of the entire rotation-symmetrical inside wall running transversely to the duct axis.

It should, however, not be ruled out that the inside wall of the pipette tip which borders the receiving space is formed by a plurality of surfaces which border one another in the circumferential direction and of which at least one is not a surface of revolution with locally constant distances to the duct axis across its angular extension. Of the mentioned surfaces, there can at least one, preferably all, be curved only about the at least one axis of curvature running transversely to the duct axis. Such a polyhedral bordering of the receiving space is preferably constructed symmetrically with respect to the duct axis in such a way that the entire inside wall is formed by a certain number of equal surface regions connected to one another in the circumferential direction. In principle, however, a single surface region configured concavely in an angular sector about the duct axis in accordance with the above description can already effect an improvement in the pulse propagation in the metering fluid in the receiving space, whilst the rest of the surface regions of the inside wall do not exhibit a concave curvature in the above sense.

Because of tapering of the pipette tip along the duct axis, the at least one axis of curvature for configuration of the concavely curved inside wall of the pipette tip is preferably oriented orthogonally to the duct axis. An inside wall section curved about an axis of curvature orthogonal to the duct axis has an impact directly and without components in the circumferential direction on the tapering of the receiving space in the axial direction towards the pipetting aperture.

For the avoidance of any misunderstandings, let it be made clear that the inside wall of the pipette tip faces towards the virtual duct axis. The pipette tip is essentially a duct component which is completely penetrated through axially by a duct. The duct can exhibit along the duct axis locally different clear widths, in particular diameters, and thereby different cross-sectional areas. The duct can even exhibit locally along the duct axis different cross-sectional shapes, although this is not preferred. There can be provided in the duct at least one filter element. For purposes of transport and of storage, a longitudinal end or both longitudinal ends of the pipette tip can be closed off by a lid or a plug.

Since the inside wall runs in a closed manner around the duct axis, it is configured concavely with respect to the duct axis. Because of the preferably at least in part, especially preferably completely, rotation-symmetrical configuration of the inside wall with respect to the duct axis as a rotation symmetry axis, according to a preferred development of the present invention the inside wall is curved in the concave axial section about the at least one axis of curvature running transversely to the duct axis and the inside wall is further configured as curved about the duct axis as a second axis of curvature. The present invention does not concern the curvature about the second axis of curvature, but rather for the avoidance of misunderstandings differentiates the curvature according to the invention which may join this curvature.

An only section-wise rotation-symmetrical configuration of the inside wall can denote both a rotation-symmetrical configuration which encircles completely in the circumferential direction in only at least one axial section, whereas at least one further axial section of the inside wall and/or of the receiving space respectively is not configured rotation-symmetrically, and also denote a rotation-symmetrical configuration in the circumferential direction only along a partly encircling circumferential section, whereas a complementary circumferential section is not configured rotation-symmetrically.

Since according to the current assessment of the available development results the concave axial section improves the propagation in the metering fluid of a pressure pulse transmitted by the working gas to the metering fluid, in order to achieve the ascertained technical advantages the concave axial section is preferably configured where metering fluid is received in the pipetting operation. Normally, metering fluid does not reach the axial section of the pipette tip which exhibits the coupling formation. Furthermore, usually a meniscus of the metering fluid received in the receiving space which lies nearer to the coupling formation does not approach the coupling formation beyond a predetermined axial minimum distance. Preferably, therefore, the concave axial section lies in an axial region of the pipette tip which starting from the pipetting aperture extends over 50% of the entire axial extension length of the pipette tip. Moreover, optionally the concave axial section can be configured only in this axial region.

Since the quantity of metering fluid in the receiving space constantly decreases exactly in the aliquoting operation, preferably the concave axial section is configured at least in an axial region which starting from the pipetting aperture extends over 35%, more preferably over 25%, even more preferably over 10%, especially over 5% of the entire axial extension length of the pipette tip. Thereby it is made sure that even with an only small metering fluid quantity received in the receiving space, the technical advantages of the concave configuration of the receiving space described above are utilizable. Preferably this does not mean that the concave axial section is configured only in the mentioned axial regions of the pipette tip, but rather that the concave axial section is configured at least also in the mentioned axial regions of the pipette tip. In principle, the entire receiving space between the coupling formation and the pipetting aperture can be the concave axial section.

According to a preferred development of the invention, the concave axial section achieves an especially advantageous effect in terms of accuracy and the smallest possible repeatable dispensing quantity by having the receiving space taper in the concave axial section in the direction towards the pipetting aperture in such a way that along the entire concave axial section it is the case that of two clear cross-sections of the receiving space observed at arbitrary different axial positions along the duct axis, the cross-sectional area of the cross-section lying nearer to the pipetting aperture is no greater than the cross-sectional area of the cross-section lying further away from the pipetting aperture. This preferred development rules out a radial widening of the receiving space restricted locally to an axial region. Such widening could lead to undesirable diffusion of a pressure pulse propagating in the metering fluid towards the pipetting aperture. Nevertheless, the above definition allows local cylindrical axial regions. Experiments, however, have shown that a concentration of the pressure pulse propagating in the receiving space within the metering fluid towards the pipetting aperture can be advantageously influenced thereby that of two clear cross-sections of the receiving space observed at arbitrary different axial positions along the duct axis, the cross-sectional area of the cross-section lying nearer to the pipetting aperture is smaller than the cross-sectional area of the cross-section lying further away from the pipetting aperture.

Preferably, therefore, the receiving space tapers constantly at least in the concave axial section towards the pipetting aperture. Especially preferably, the entire receiving space tapers constantly along the duct axis.

Incidentally, when there is mention of a ‘cylindrical’ shape in the present application, there is denoted thereby a cylindrical shape in in its most general form, i.e. a shape generated by a closed encircling planar curve which as a shape generatrix is displaced orthogonally to its extension plane. Solely as a preference, the cylindrical shape is a circularly cylindrical shape.

As set forth above, the receiving space or rather the inside wall of the pipette tip bordering it radially is configured symmetrically with respect to the duct axis as axis of symmetry. In the preferred case, this symmetry can be rotational symmetry with the duct axis as rotational symmetry axis. In another case, this symmetry can consist in the inside wall being formed by a number of surface sections of which at least two are convertible into one another through rotation about the duct axis. The concave curvature of the inside wall which is of interest here can be observed especially advantageously at the contour line which the inside wall exhibits in a sectional view in a longitudinal section plane containing the duct axis. In the aforementioned case of a polyhedral concave receiving space, the contour line in the concave axial section is a polygon. Preferably, however, the contour line in the concave axial section is curved, in particular curved jump- and step-free.

In principle, to achieve the desired effect there suffices a concave axial section in which in a single longitudinal section of a longitudinal section plane containing the duct axis the contour line of the inside wall of the pipette tip bordering the concave axial section exhibits exactly one radius of curvature. The concavely curved contour line is then a circle segment. A rotation-symmetrical inside wall section formed from it exhibits the shape of a spherical calotte section.

For the most effective possible concentration of a pressure pulse propagating in the metering fluid received in the receiving space in the direction towards the pipetting aperture, however, it has proved advantageous if the contour line of the inside wall in the concave axial section exhibits along its axial extension more than one radius of curvature. Preferably, it is the case for a longitudinal sectional view in at least one longitudinal section plane containing the duct axis that the curvature of a contour line of the inside wall of the pipette tip bordering the concave axial section radially does not become smaller and/or weaker as the case may be on approaching the pipetting aperture. Curvature becoming smaller means radii of curvature becoming greater. Especially preferably, the curvature of the contour line becomes constantly greater and/or stronger as the case may be on approaching the pipetting aperture, i.e. the local radii of curvature of the contour line become especially preferably constantly smaller on approaching the pipetting aperture.

With regard to the aforementioned preferred symmetry cases, the above comments concerning the curvature of the contour line preferably apply to longitudinal sectional views in several longitudinal section planes containing the duct axis, especially preferably in all such longitudinal section planes.

A preferred contour line of the inside wall of the pipette tip bordering the concave axial section radial with curvature constantly increasing towards the pipetting aperture can be obtained through a hyperbolic contour line.

Conversely, it is the case that with distance away from the pipetting aperture, the curvature of the contour line in the denoted at least one longitudinal section plane containing the duct axis preferably becomes constantly smaller. If h denotes a coordinate along the duct axis whose origin lies at the end of the concave axial section lying nearer to the pipetting aperture and which with increasing distance away from the pipetting aperture becomes greater in magnitude in linear proportion to the distance, then the contour line M, given by the radial distance M(h) of the contour line from the duct axis at the axial coordinate h, can exhibit a course with the following hyperbolic structure:

$$M ( h ) = {K}_{1} + {K}_{2} \cdot \frac{h}{h + {K}_{3}} \qquad GI . 1$$

K₁, K₂, and K₃ are constants. Each one of the individual constants K₁, K₂, and K₃ can be negative. K₁ is preferably a function of the radial distance of the contour line from the duct axis at the longitudinal end of the contour line and/or of the concave axial section respectively which lies nearer to the pipetting aperture or is this radial distance. K₁ is therefore preferably a positive value. K₁, K₂, and K₃ differ in magnitude from zero.

K₂ and K₃ are preferably each functions of the distance of the contour line from the duct axis at the longitudinal end of the contour line and/or of the concave axial section respectively which lies nearer to the pipetting aperture, at the longitudinal end of the contour line and/or of the concave axial section respectively which lies further away from the pipetting aperture, of the axial length of the concave axial section, and of the inclination angle of the contour line at the longitudinal end of the contour line which lies nearer to the pipetting aperture. Preferably, K₂ is a function of K₃ also.

With rₙ as the radial distance of the contour line from the duct axis at the longitudinal end of the concave axial section which lies nearer to the pipetting aperture (h=0), r_{f} as the radial distance of the contour line from the duct axis at the longitudinal end of the concave axial section which lies further away from the pipetting aperture (h=h_{end}), and with IKA as the axial length of the concave axial section, Equation 1 can be written in an advantageous form:

$$M ( h ) = {r}_{n} + ( {r}_{f} - {r}_{n} ) ( 1 - \frac{{K}_{3}}{{l}_{KA}} ) \cdot \frac{h}{h + {K}_{3}} \qquad GI . 2$$

Where for K3 in a preferred embodiment we have:

$${K}_{3} = {l}_{KA} \cdot \frac{{r}_{f} - {r}_{n}}{{r}_{f} - {r}_{n} - {l}_{KA} \cdot tan ( - α )} \qquad GI . 3$$

with α as the inclination angle of the contour line at the longitudinal end of the concave axial section which lies nearer to the pipetting aperture.

In principle, the concave axial section can extend over the entire receiving space. As already set forth above, however, it is sufficient to configure only an axial section of the receiving space which lies nearer to the pipetting aperture as the concave axial section.

Therefore it can be provided that in an axial region lying between the coupling formation and the concave axial section of the pipette tip there is configured a second axial section of the receiving space whose inside wall bordering it radially differs from the inside wall in the concave axial section with regard to at least one parameter out of inclination relative to the duct axis and curvature about an axis of curvature running transversely to the duct axis. Preferably, for reasons of simple fabrication, this second axial section is a conical section with at least one, preferably exactly one, cone angle constant along its axial extension. This cone angle preferably lies between 3.5° and 4.5°. In the present application, the term ‘cone angle’ always denotes the complete cone angle, not the half cone angle between the cone axis and a straight line lying on the cone surface.

By way of this second axial section, an axial region of the receiving space can be configured for the storage of a comparatively larger fluid quantity per axial length than in the concave axial section. Hereby, the pipette tip despite its ability to meter fluid quantities in the range below 1 μl with repeat accuracy, can receive in the receiving space and hold ready for dispensing a comparatively large fluid quantity in the two- or even three-figure microliter range. For example, the pipette tip can exhibit a nominal capacity volume of at least 10 μl or of at least 50 μl, including the mentioned limits. For especially extensive pipetting tasks, the pipette tip can exhibit a nominal capacity volume of at least 90 μl or preferably of at least 130 μl. The pipette tip being discussed here can be used both for displacement-based and for pulse-based pipetting, although the advantage of the configuration of the concave axial section is especially useful in pulse-based pipetting. Therefore a pipette tip as discussed here can also exhibit a nominal capacity volume of at least 150 μl, even though with the pulse-based dispensing method often only single doses of 50 to 120 nl are dispensed.

A nominal capacity volume of more than 500 μl is possible in principle, but because of the comparatively large working gas volume between the pipetting aperture-nearer piston surface of a piston of a pipetting duct coupling the pipette tip and the pipetting aperture no longer preferred. Preferably, therefore, the pipette tip exhibits a nominal capacity volume of not more than 500 μl, especially preferably of not more than 350 μl, more strongly preferably of not more than 300 μl. In an advantageous embodiment, the pipette tip therefore exhibits a nominal capacity volume of not more than 265 μl.

The second axial section, which preferably exhibits a greater axial length than the concave axial section, can be configured in the direction from the coupling longitudinal end to the metering longitudinal end in a tapering manner in such a way and/or can extend with a specified taper over an axial length as the case may be in such a way that its second clear width orthogonally to the duct axis at its end which lies nearer to the metering longitudinal end is equal to between 40% and 60% of a first clear width parallel to the second clear width at its end which lies nearer to the coupling longitudinal end. Preferably the second clear width equals 50% of the first clear width. With a square cross-section of the receiving space, the clear width can be an edge length or a diagonal. Due to the preferred configuration of the receiving space as a rotation-symmetrical receiving space, the clear width is preferably a diameter. The first clear width can preferably equal between 3 mm and 7 mm, especially preferably between 3.5 mm and 5.5 mm, and most preferably between 3.8 mm and 4.2 mm. In an especially preferred advantageous embodiment, the first clear width equals exactly 4 mm.

In principle it can be provided that the concave axial section ends at the pipetting aperture. Experiments have shown, however, that although this is good for the formation of the dispensed drop of metering fluid, this is not optimal, in particular in pulse-based dispensing. A better pipette tip, because it dispenses a single drop without satellite drops, is obtained according to a preferred development of the present invention, by having configured axially between the concave axial section and the pipetting aperture a third section of the receiving space as an aperture conduit section, whose inside wall bordering it radially differs from the inside wall in the concave axial section and in the second axial section with regard to at least one parameter out of inclination relative to the duct axis and curvature about an axis of curvature running transversely to the duct axis and clear width orthogonally to the duct axis.

The aperture conduit section preferably comprises
i.) A conical section, with a cone angle of not more than 6°, where preferably the duct axis is the cone axis of the conical section, and/or
ii.) A bulging section encircling the duct axis in the shape of a concave section or of a convex section with a bulge radius equal at least to ten times the axial length of the bulging section, and/or
iii.) A cylindrical section, where preferably the duct axis is the cylinder axis of the cylindrical section.

A circularly cylindrical section as aperture conduit section of the receiving space is preferred. Because of the preferred very short configuration of the aperture conduit section in comparison with the rest of the mentioned axial sections, it can also exhibit encircling bulging surface with a large radius of curvature mentioned under ii.), although iii.) and within iii.) the circularly cylindrical configuration is preferred. The cylindrical configuration allows advantageous preconditioning of the metering fluid received in the receiving space known from WOXXX 2018/108825 A of the applicant with regard to the shape of its pipetting aperture-nearer meniscus and its distance from the pipetting aperture itself. This makes possible not only fluid dispensing in very small quantities with high repeat accuracy, but also targeted pulse-based dispensing of these small metering fluid quantities along the virtual duct axis.

In a very short axial transitional region between the concave axial section and the aperture conduit section, the inside wall can exhibit an edge or a transitional axial section convexly curved with respect to an axis of curvature running transversely, preferably orthogonally, to the duct axis. The radius of curvature of the convex curvature of the inside wall in the transitional axial section preferably equals less than 0.6 mm, especially preferably less than 0.4 mm, and even more preferably less than 0.3 mm. In a preferred embodiment, the radius of curvature equals 0.2 mm.

The pipetting aperture preferably exhibits a clear width, in particular a diameter, orthogonal to the duct axis with a dimension of less than 0.38 mm. This is less than in the known and proven pipette tip “CO-RER”, which with a nominal capacity volume of 50 μl exhibits a pipetting aperture diameter of 0.4 mm. The dimension of the clear width of the pipetting aperture, in particular as diameter, is preferably smaller than 0.3 mm, especially preferably the dimension of the clear width, in particular as diameter, equals 0.275 mm.

The dimension of the clear width, in particular as diameter, of the pipetting aperture is preferably greater than 0.2 mm, especially preferably greater than 0.25 mm.

Up to now, only the interior shape of the pipette tip defined by the inside wall of the pipette tip has been described.

A radially outward-facing outside wall of the pipette tip in an extension section overlapping axially with the aperture conduit section can according to a preferred embodiment of the invention
i.) Exhibit when viewed from outside concave curvature about at least one axis of curvature running transversely to the duct axis
   and/or
ii.) Exhibit when viewed from outside convex curvature about at least one axis of curvature running transversely to the duct axis
   and/or
iii.) Be configured as tapering towards the pipetting aperture, in particular tapering conically
   and/or
iv.) Be configured cylindrically.

The outside wall of the pipette tip in an extension section overlapping axially with the aperture conduit section is preferably configured rotation-symmetrically with the duct axis as rotation symmetry axis. The axis of curvature of the outside wall running transversely to the duct axis preferably runs orthogonally to the duct axis.

Preferably, the extension section overlapping axially with the aperture conduit section starts off from the metering longitudinal end of the pipette tip.

From the perspective of a desirable smallest possible wetting of the pipetting aperture-nearer outside wall of the pipette tip, case ii.) is preferable where especially preferably the outside wall starting from the metering longitudinal end is configured continuously up into the concave axial section, especially preferably up to the pipetting aperture-remoter end of the concave axial section in accordance with ii.), i.e. with convex curvature with respect to the axis of curvature. The outside wall is therefore in this especially preferable case curved convexly about the duct axis and is additionally curved convexly about axes of curvature orthogonal to the duct axis. Preferably, there are no further curvatures of the outside wall. This means that in the region of the aperture conduit section the contour of the outside wall of the pipette tip does not follow the contour of the aperture conduit section.

Preferably the convex curvature of the outside wall, in particular starting from the pipetting aperture, when progressing in the direction away from the metering longitudinal end, becomes not stronger, especially preferably weaker, more strongly preferably constantly weaker. This applies especially preferably up to the pipetting aperture-remoter longitudinal end of the concave axial section.

The generatrix of a rotation-symmetrical outside wall of the pipette tip too, can exhibit in at least one, preferably in several, especially preferably in all longitudinal sectional views in a longitudinal section plane containing the duct axis an in principle hyperbolic course, because of the advantageous wetting behavior especially preferably starting directly from the metering longitudinal end. This too, applies especially preferably up to the pipetting aperture-remoter longitudinal end of the concave axial section.

It should, however, not be ruled out that the pipette tip in the region of the aperture conduit section exhibits a cylindrical or conical collar, therefore the outside wall of the pipette tip in the region of the aperture conduit section is configured conically or cylindrically, in particular circularly cylindrically, and only at a distance from the pipette tip, for instance in the region of a transition from the aperture conduit section to the concave axial section, transitions into a convex shape which preferably is distanced by the in this case orthogonally to the duct axis to be measured material thickness of the pipette tip from the concave shape of the inside wall. Then the shape of the outside wall in the concave axial section preferably follows the shape of the inside wall. In doing so, the wall thickness can vary in magnitude along the axial extension of the pipette tip and in particular of the concave axial section or also of the second axial section, such that the shape sequence of the outside wall relative to the inside wall is preferably a qualitative shape sequence. In particular, according to a design option, the wall thickness in the axial direction can at least in the concave axial section decrease towards its pipetting aperture-nearer longitudinal end, preferably decrease continuously, i.e. kink- and step-free. Through such decreasing wall thickness, the stiffness of the pipette tip can be reduced locally which in turn can impact the propagation of a pressure pulse in received metering fluid. For example, through lowered stiffness of the pipette tip in the region of the concave axial section, undesirable post-oscillation of the pipette tip in the concave axial section, excited by the propagation of a pressure pulse, can be reduced in magnitude or even excluded completely. Lower stiffness of the pipette tip which is made from a synthetic is normally accompanied by higher inner damping of the pipette tip. Due to the preferred fabrication of the pipette tip through injection molding, the synthetic is preferably a thermoplastic. Under these, polyolefins are preferred, where under the polyolefins in turn polypropylene is preferred, which exhibits a somewhat higher temperature stability than polyethylene. The pipette tip is preferably made from one and the same material to at least 90 wt. %, more preferably to 95 wt. %, in order to allow recycling and/or recovery of the pipette tip in a single recycling stream. Therefore, most preferably the pipette tip is made from one and the same material to 100 wt. %, ignoring unavoidable impurities.

The thermoplastic synthetic can be formed conventionally or from renewable resources. It can be used filled or unfilled, with the thermoplastic synthetic used to form the pipette tip being preferably colorless, more preferably translucent, even more preferably transparent. Possible fillers to consider include particles and/or fibers selected out of: graphite, flax, hemp, sugar cane, and the like, to name only a few possible fillers.

The axial length of the concave axial section can preferably equal between 15% and 60% of the total length of the pipette tip. The axial length of the second axial section can equal between 35% and 70% of the total length of the pipette tip. The axial length of the aperture conduit section can equal between 0.8% and 3% of the total length of the pipette tip. The total percentage lengths of the axial sections come to than 100%, since the coupling axial section also contributes to the total length of the pipette tip but takes no part in the axial sections: aperture conduit section, concave axial section, and second axial section. With the coupling axial section, the sum of the axial dimensions of aperture conduit section, concave axial section, and second axial section equals 100% of the axial total length of the pipette tip.

Regardless of the total length of the pipette tip, out of fluid mechanical considerations the aperture conduit section has a length of at least 0.35 mm, preferably of at least 0.4 mm, and especially preferably of exactly 0.5 mm. Likewise preferably, the aperture conduit section is no longer than 0.8 mm, preferably no longer than 0.7 mm, and especially preferably no longer than 0.6 mm.

The pipette tip exhibits preferably a total length of at least 35 mm, preferably of at least 45 mm, especially preferably of at least 50 mm, and even more strongly preferably of exactly 52.5 mm. Likewise the pipette tip preferably exhibits a total length of no more than 90 mm, preferably of no more than 75 mm, especially preferably of no more than 65 mm.

The concave axial section preferably exhibits a length of at least 7 mm, especially preferably of at least 8.5 mm, and even more preferably of at least 9 mm. Most preferably, the concave axial section exhibits a length of exactly 10 mm. Likewise, the concave axial section exhibits preferably a length of no more than 20 mm, especially preferably of no more than 16 mm, and even more preferably of no more than 13 mm.

The second axial section preferably exhibits a length of at least 20 mm, especially preferably of at least 25 mm, even more preferably of at least 28 mm, and most preferably of exactly 30 mm. likewise the second axial section exhibits preferably a length of no more than 50 mm, especially preferably of no more than 40 mm, and even more preferably of no more than 35 mm.

The coupling axial section preferably equals approximately 15% to 35% of the total length of the pipette tip. In absolute values, the coupling axial section including a transitional section to the second axial section connected to it axially is preferably at least 7 mm long, especially preferably at least 9 mm long, even more preferably at least 11 mm long, and most preferably exactly 12 mm long. Likewise the axial length of the coupling axial section is preferably no greater than 20 mm, especially preferably no greater than 16 mm, and even more preferably no greater than 14 mm.

The coupling formation is preferably a shape of an inside wall of the pipette tip facing towards the duct axis, into which a coupling counter-formation penetrates axially in order to fix the pipette tip temporarily onto the coupling counter-formation. The inside wall of the coupling formation preferably exhibits an encircling latching recess indented radially outwards, which is configured for engaging with a radially expanding elastic element, in particular the O-ring mentioned in the beginning. The coupling formation is preferably configured like the coupling formation of the known CO-RER pipette tips, in order to be able to ensure the use of the pipette tips according to the invention on the pipetting devices using the CO-RER pipette tips of the applicant up to bow. The preferably rotation-symmetrical latching recess with respect to the duct axis as rotation axis exhibits in a longitudinal sectional view containing the duct axis a contour line curved about an axis of curvature orthogonal to the duct axis, which moves away from the duct axis along its axial extension and approaches the duct axis again.

Likewise, the coupling formation preferably exhibits a radial ledge as a stop surface for abutment against a coupling counter-formation. Accordingly, the inner diameter of the pipette tip decreases sharply from an axial coordinate starting from the coupling longitudinal end. Preferably, this axial coordinate lies starting from the coupling longitudinal end at between 3.5 and 6.5 mm.

The axial sections described here are directly axial sections of the receiving space of the pipette tip or more precisely of a duct traversing the pipette tip axially. The axial sections are besides used as location or regional information of the pipette tip overall.

According to the above elucidations, let it be made clear that the present invention also concerns a use of a pipette tip, as it is described and developed above, for pulse-based dispensing of a metering fluid received in the pipette tip together with a working gas.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 An elevation view of a first embodiment of a pipette tip according to the invention,

FIG. 2A longitudinal sectional view of the pipette tip of the first embodiment in the longitudinal section plane II-II containing the duct axis of FIG. 1,

FIG. 3 An enlarged depiction of the metering longitudinal end of the first embodiment in a longitudinal section,

FIG. 4 An enlarged depiction of a metering longitudinal end of a second embodiment of a pipette tip according to the invention in a longitudinal section, and

FIG. 5 An enlarged depiction of a metering longitudinal end of a third embodiment of a pipette tip according to the invention in a longitudinal section.

### DESCRIPTION OF PREFERRED EMBODIMENTS

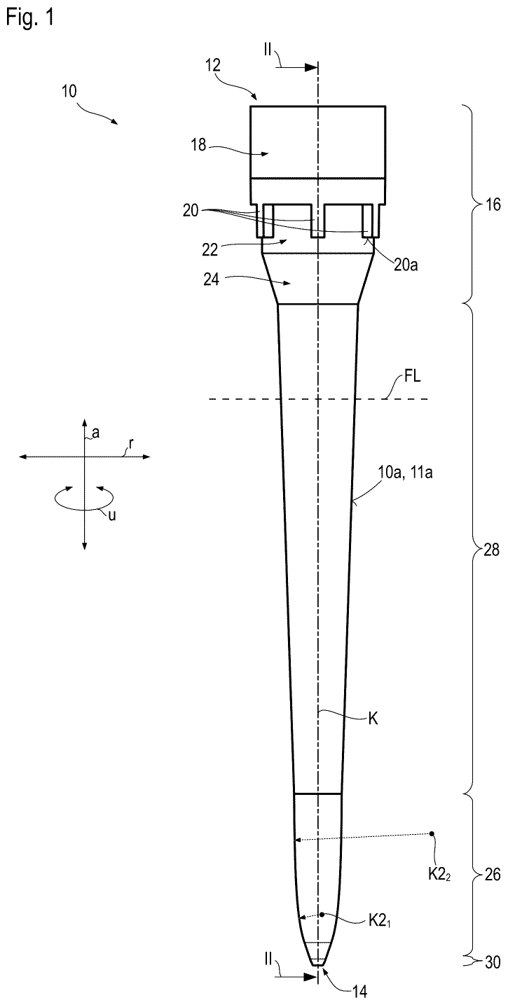

Referring now to the drawings wherein the showings are for the purpose of illustrating preferred and alternative embodiments of the invention only and not for the purpose of limiting the same, in FIG. 1, an elevation view of a first embodiment of a pipette tip according to the invention is labeled generally by 10. The pipette tip 10 extends along a straight duct axis K, which runs in parallel to the drawing plane of FIG. 1. The duct axis K defines an axial direction a running along the duct axis K, radial directions r running orthogonally to the duct axis K, and a circumferential direction u encircling the duct axis K.

The pipette tip 10 is oriented in FIG. 1 in accordance with its arrangement in a pipetting operation, i.e. the upper end in FIG. 1 is configured as a coupling longitudinal end 12 for coupling with a pipetting duct of a pipetting device and the lower end in FIG. 1 is configured as a metering longitudinal end 14 for receiving metering fluid in a receiving space 36 of the pipette tip 10 and for dispensing metering fluid out of the latter.

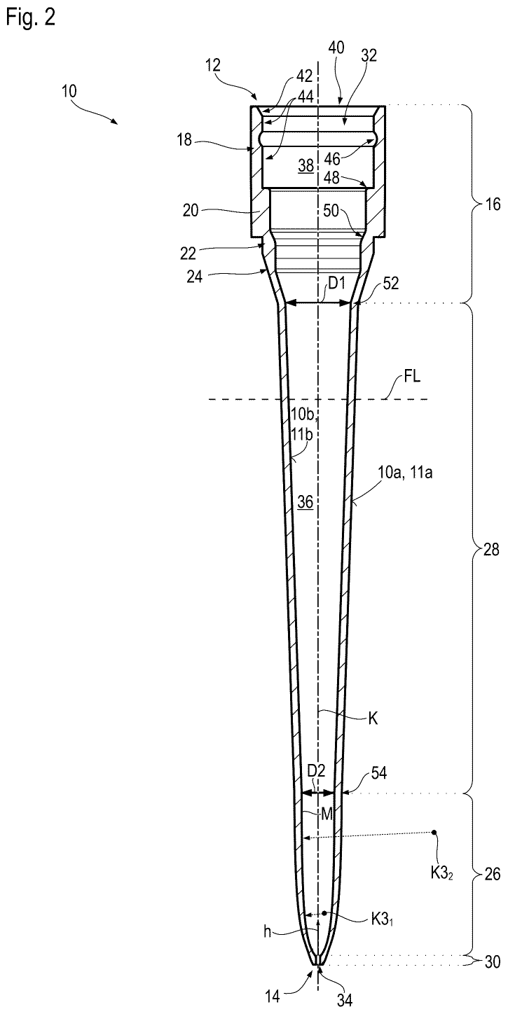

The pipette tip 10 exhibits at its coupling longitudinal end 12, starting from the coupling longitudinal end 12, a coupling axial section 16 not normally reached by metering fluid, which preferably starting from the metering longitudinal end 14 rises through aspiration in the axial direction and is received in the pipette tip 10. The maximum nominal filling height of the pipette tip 10 is indicated in FIGS. 1 and 2 by the dashed line FL.

In the coupling axial section 16 there are configured on the outside 10a of the pipette tip 10 projecting in the axial direction a from an end-side cylindrical or weakly inclined conical annular section 18 towards the metering longitudinal end 14 supporting crenelations 20, on an end face 20a of which, facing in the axial direction a, the pipette tip 10 can be provided at rest in a not depicted carrier receptacle for reception by a pipetting device. The supporting crenelations 20 are arranged equidistantly distributed in the circumferential direction u. Instead of the supporting crenelations 20, the annular section 18 could also be configured axially lengthened, such that instead of individual end faces 20a a closed encircling annular end face could serve as a supporting surface for the pipette tip 10. However, for more secure reception of a pipette tip 10 by a pipetting device from a carrier providing the pipette tip 10 it is advantageous if the supporting surface of the pipette tip 10 resting on a carrier surface is as small as possible in order to avoid undesirable adhesion effects between pipette tip and carrier. Such adhesion effects could hinder lifting the pipette tip 10 out of the carrier. Furthermore, material can be saved through the configuration of supporting crenelations 20 compared with a solid annular section.

The supporting crenelations 20 project radially outward over a once again cylindrical or weakly inclined conical second annular section 22 of the outside wall 11a of the pipette tip 10. To this second annular section 22 there is connected a comparatively steep conical section 24 of the outside wall 11a.

To the coupling axial section 16, which in the proper pipetting operation is not reached by metering fluid, there are connected axially those axial sections of the pipette tip 10 which at least in part receive metering fluid during the pipetting operation.

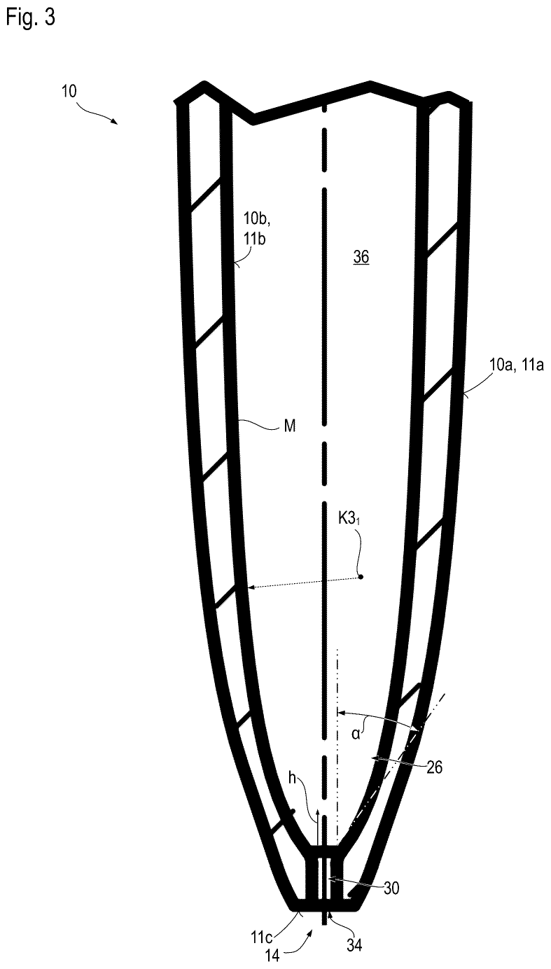

The most relevant axial section for the present application is the concave axial section 26, which receives its name through the special design of the inside wall 11b on the inner side 10b of the pipette tip in the concave axial section 26. This is elucidated in greater detail further below in connection with FIGS. 2 and 3.

In the first embodiment example of the pipette tip 10 depicted in FIG. 1, the outside wall 11a, with the exception of the axial section forming the supporting crenelations 20, is configured rotation-symmetrically with the duct axis K as rotation symmetry axis. The outside wall 11a is therefore curved convexly about the duct axis K.

However, in the first embodiment example the outside wall 11a of the pipette tip 10 is likewise curved convexly, starting from the metering longitudinal end 14 in the axial direction towards the coupling longitudinal end 12 up to the end of the concave axial section 26 lying distally to the metering longitudinal end 14, about at least one axis of curvature K2 orthogonal to the duct axis K. Because of the rotation-symmetrical configuration of the outside wall 11a, the contour line of the outside wall 11a displays the curvature convex to the axis of curvature K2 in FIG. 1. The radii of curvature outbound from the axes of curvature K2₁ and K2₂ are depicted symbolically as dashed lines. With the exception of the axial section in which the supporting crenelations 20 are configured which break the strict rotation symmetry of the rest of the pipette tip, the elevation view of the pipette tip 10 is invariant under rotation of the pipette tip 10 about the duct axis K.

Through the equidistant arrangement in the circumferential direction of the uniformly configured supporting crenelations 20, the axial section of the pipette tip 10 exhibiting the supporting crenelations 20 is also symmetrical with respect to the duct axis K at least in so far that an elevation view of this axial section with a number k of supporting crenelations 20 is invariant under a rotation of the pipette tip 10 by a rotation angle of 360°/k.

In FIG. 1, two axes of curvature K2 (as axes K2₁ and K2₂) are marked as examples for the contour line of the outside wall 11a lying to the left of the duct axis K, where the axes of curvature K2 run orthogonally to the drawing plane of FIG. 1. FIGS. 1 to 5 are not to scale, which is why the distance of the respective axes of curvature K2 indicates the respective radius of curvature indicated by a dashed line as the distance of the outside wall 11a from the respective axis of curvature K2 only qualitatively, but not quantitatively.

The convex curvature of the contour line and thus of the outside wall 11a of the pipette tip 10 in the concave axial section 26 with respect to the at least one axis of curvature K2 running orthogonally to the duct axis K is not constant along the duct axis K, but rather decreases with increasing distance from the metering longitudinal end 14. This means that the radii of curvature, which indicate the convex curvature about an axis of curvature K2, become greater in the concave axial section 26 with increasing distance from the metering longitudinal end 14. For this reason, the convex curvature of the outside wall 11a of the pipette tip 10 in the concave axial section 26 is not determined by a single axis of curvature K2 orthogonal to the duct axis K, but rather by a plurality of axes of curvature K2 following one another along the duct axis K, each of which can be thought of as rotating about the duct axis K with the contour line.

Axially between the concave axial section 26 and the coupling axial section 16 there is situated a second axial section 28, in which the outside wall 11a of the pipette tip 10 is configured conically. The cone angle of the outside wall 11a in this section, measured from contour line to contour line across the duct axis K, equals between 3.75° and 3.85°.

Axially between the concave axial section 26 and the metering longitudinal end 14 there is situated an aperture conduit section 30, in which the outside wall 11a of the pipette tip 10 is configured conically with the duct axis K as cone axis or convexly curved about at least one not depicted further axis of curvature K2 orthogonal to the duct axis K.

FIG. 2 shows a longitudinal sectional view of the pipette tip 10 of FIG. 1 along the section plane II-II of FIG. 1 containing the duct axis K. A duct 32 traverses the pipette tip 10 axially completely from the coupling longitudinal end 12 up to the metering longitudinal end 14. In the duct 32 there can be accommodated a filter, which however is not the case in the depicted embodiment. The duct 32 is configured in the depicted embodiment example over its entire axial length rotation-symmetrically with respect to the duct axis K as rotation symmetry axis.

Cross-sections of the duct 32 along the duct axis K in cross-sectional planes orthogonal to the duct axis K are therefore circles, where the diameter of the respective cross-sectional circle at different axial positions of the cross-section along the duct axis K can be different in size.

The duct 32 comprises a receiving space 36 starting off from the pipetting aperture 34 at the metering longitudinal end 14, which serves for receiving metering fluid in the pipette tip 10, and comprises a coupling space 38 which serves for coupling with a pipetting duct of a pipetting device.

Starting off from the coupling longitudinal end 12 axially in the direction towards the metering longitudinal end 14, the inside wall 11b is configured on the inner side 10b of the pipette tip as a coupling formation 40.

To begin with, the coupling formation 40 already widely known from the state of the art will be described briefly: Starting from the coupling longitudinal end 12, the inside wall 11b of the pipette tip first exhibits an insertion chamfer 42 which aids axial physical insertion of a coupling counter-formation into the coupling space 38.

The insertion chamfer 42 is followed by a wall section 44 which is cylindrical or slightly conically tapering in the direction away from the coupling longitudinal end, for instance with a full cone angle of between 1° and 5°, in which in an axial section there is configured a rotation-symmetrical latching recess 46 completely encircling the duct axis K, indenting the inside wall 11b radially outwards, for positive locking engagement with a radially movable latching element of the coupling counter-formation.

At the longitudinal end of the wall section 44 distal to the coupling longitudinal end 12 the coupling formation 40 exhibits an encircling radial ledge 48 as an axial stop for accurate relative positioning of coupling counter-formation and coupling formation 40 in the axial direction. Further distally from the coupling longitudinal end 12 in the axial direction than the radial ledge 48 there is configured a negatively conical abutment surface 50 for a seal provided at the coupling counter-formation.

At a certain safety distance axially away from the conical abutment surface 50, in order to prevent metering fluid received in the receiving space 36 reaching the coupling formation 40 and/or the coupling counter-formation inserted in it as the case may be, there begins at reference mark 52 the second axial section, in which the inside wall 11b of the pipette tip 10 exhibits a starting diameter D1. The full cone angle of the inclination of the inside wall 11b in the conical, actually: negatively conical, second axial section 28 is equal to the aforementioned full cone angle of the outside wall 11a of the pipette tip in the same second axial section 28. The starting diameter can preferably equal between 3 mm and 5 mm and equals in the especially preferred depicted embodiment example 4 mm.

The length of the second axial section 28 preferably equals between six times and nine times the starting diameter D1, for preference between seven times and eight times the starting diameter D1. In the depicted example, the length of the second axial section 28 equals 7.5 times the starting diameter D1. The second axial section 28 ends at reference mark 54, where the receiving space 36 exhibits a diameter D2 which exhibits between one third and two thirds, more preferably between 40% and 60%, of the dimension of the starting diameter D1. In the depicted embodiment example, the diameter D2 is half as great as the starting diameter D1.

To the second axial section 28 there now connects axially directly the current especially interesting concave axial section 26. In this concave axial section 26, the contour line M, which exhibits the inside wall 11b of the pipette tip 10 with the longitudinal section plane II-II, is configured concavely curved about at least one, preferably about several axes of curvature K3 orthogonal to the duct axis K.

Since the inside wall 11b in terms of shape essentially follows the outside wall 11a of the pipette tip 10 in the concave axial section 26, the axes of curvature K3, i.e. K3₁ and K3₂, marked by way of example, lie radially distanced by the respective wall thickness from the axes of curvature K2 indicating the convex curvature of the outside wall 11a, i.e. K2₁ and K2₂. For the inside wall 11b also and specifically, it is the case in the concave axial section 26 that the curvature of the contour line as shape-generating line of the rotation—symmetrical inside wall 11b preferably decreases continuously, i.e. the radii of curvature which once again are depicted symbolically as dashed lines increase with progression along the from nearer to the pipetting aperture 34 lying axial longitudinal end of the concave axial section 26. A location variable h begins at the axial longitudinal end of the concave axial section 26 lying nearer to the pipetting aperture 34 and takes increasing values along the duct axis K in the direction towards the axial longitudinal end of the concave axial section 26 lying further away from the pipetting aperture 34 in linear proportion to the distance from the pipetting aperture-nearer longitudinal end.

In the concave axial section 26 the contour line M is preferably a hyperbolic contour line, which is given structurally by the above Equation 1. Its curvature constantly decreases with increasing distance from the longitudinal end of the concave axial section 26 lying nearer to the pipetting aperture 34 in the direction towards the longitudinal end of the concave axial section 26 lying further away from the pipetting aperture 34, or respectively constantly increases on approaching the longitudinal end of the concave axial section 26 lying nearer to the pipetting aperture 34, starting from the longitudinal end of the concave axial section 26 lying further away from the pipetting aperture 34.

Because of the rotation-symmetrical configuration of the inside wall 11b in the concave axial section 26, what was said for the contour line M applies to the entire inside wall 11b in the concave axial section 26.

Through this physical configuration of the inside wall 11b and thereby of the receiving space 36 in the concave axial section 26, a pressure pulse created in a working gas in the coupled pipetting duct of a pipetting device, which is normally created in an axial region of the pipetting duct outside the pipette tip 10, propagates along the duct axis K in the direction towards the pipetting aperture, and impinges on a boundary surface lying further away from the pipetting aperture 34 of a metering fluid received in the receiving space 36, can propagate especially advantageously in the metering fluid along the duct axis K in the concavely curved concave axial section 26. On this pressure pulse reaching the boundary surface of the received metering fluid lying nearer to the pipetting aperture 34, the pressure pulse effects an overcoming of the surface tension of the metering fluid at the boundary surface, whereby a metering fluid drop in the sub-microliter range, preferably with a drop volume smaller than 500 nl, especially preferably smaller than 100 nl, can be flung off with repeatably accurate metering quantity. Depending on viscosity and on the surface tension of the metering fluid, metering fluid drops with a drop volume of not less than 30 nl, more reliably of not less than 50 nl, and especially reliably of not less than 70 nl can be pulse-based dispensed with repeat accuracy.

The concave axial section 26 of the receiving space 36 does not, however, end directly at the pipetting aperture 34, although according to the present invention this would in principle be possible. Axially between the pipetting aperture 34 and the longitudinal end of the concave axial section 26 lying nearer to the pipetting aperture 34 there is situated a preferably cylindrical aperture conduit section 30 of the duct 32 or of the receiving space 36 respectively. The aperture conduit section 30 exhibits a diameter of less than 10%, preferably of less than 7%, of the starting diameter D1. In the depicted embodiment example, the aperture conduit section 30 exhibits a diameter of 0.275 mm.

The aperture conduit section 30 serves, with regard to pulse-based dispensing, for providing the most defined pipetting aperture-nearer meniscus possible of the metering fluid received in the receiving space 36. Through targeted changes of the working gas pressure in the pipetting duct and thereby also at least in the end region of the receiving space 36 lying nearer to the coupling longitudinal end 12, a planar meniscus can be formed in the aperture conduit section 30 which in addition exhibits an axial distance to the pipetting aperture 34. Should the pressure pulse propagating in the received metering fluid in the context of pulse-based dispensing impinge at the end of its propagation on the pipetting aperture-nearer meniscus preconditioned in the manner just described, pulse-based metering fluid droplets in the sub-microliter range can be dispensed with high metering accuracy and likewise with high repeat accuracy. Further fundamental data regarding the preconditioning of a metering fluid received in a receiving space of a pipette tip and its pipetting aperture-nearer meniscus for pulse-based dispensing are disclosed in WOXXX 2018/108825 A of the applicant. The pipette tip discussed here is especially suitable for implementing a pulse-based dispensing method, as disclosed in WOXXX 2018/108825 A of the applicant.

Between the aperture conduit section 30 and the concave axial section 26 there can be configured a transitional section which can be necessary in manufacturing terms, in order to transition from the cylindrical aperture conduit section 30 to the concave axial section 26 of the duct 32 or of the receiving space 36 respectively. A radius of curvature at the transition of the inside wall 11b of the pipette tip 10 axially between the aperture conduit section 30 and the concave axial section 26 can for example equal 0.2 mm.

In FIG. 3, the longitudinal sectional view of the metering longitudinal end 14 of the pipette tip 10 of FIG. 2 is shown enlarged.

Solely for clarification let it be noted that due to the rotation-symmetrical design of the inside wall 11b of the pipette tip 10 in the depicted embodiment example, every longitudinal sectional view whose longitudinal section plane contains the duct axis K shows the same contour line M as intersection line of the inside wall 11b with the longitudinal section plane.

At the longitudinal end of the concave axial section 26 lying nearer to the pipetting aperture 34, the contour line M and thereby the inside wall 11b has an inclination of the angle α with respect to the duct axis K. The angle α can preferably equal between 35° and 50°, especially preferably between 35° and 45°, even more preferably between 37.5° and 42.5°, and most preferably equals exactly 40°.

An end face 11c of the pipette tip 10 encircling the pipetting aperture 34 in a closed manner is preferably planar, i.e. a planar annular surface. It can alternatively also exhibit a convex curvature, preferably about at least one axis of curvature orthogonal to the duct axis K. For example, the end face 11c can be configured as part of a toroidal surface, which one obtains when cutting a torus with a plane oriented orthogonally to the torus axis. Since a greater part of the outside 10a of the pipette tip 10 is rotation symmetrical, the torus axis too is preferably a rotation symmetry axis of the torus.

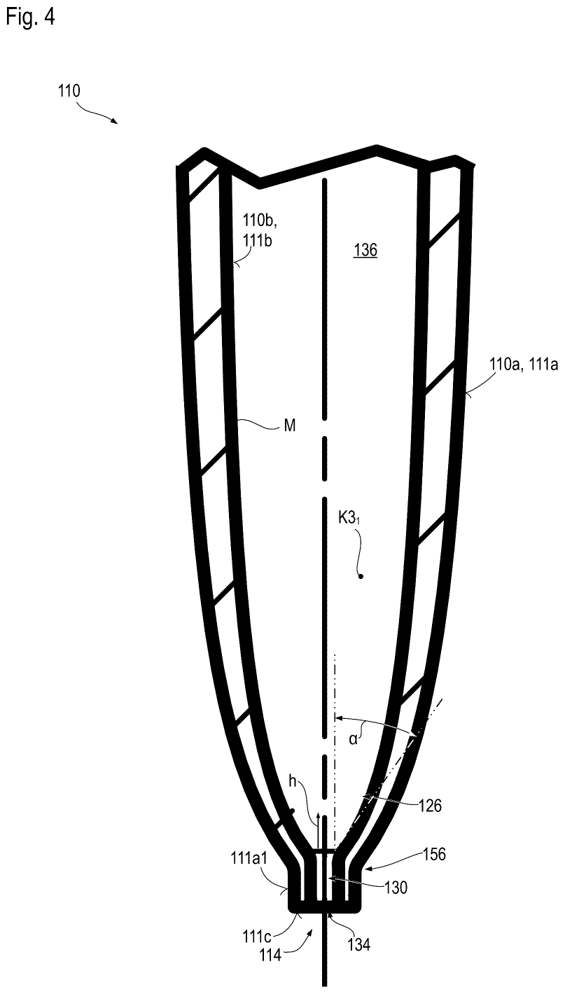

In FIG. 4 there is depicted an enlarged view corresponding to FIG. 3 of the metering longitudinal end 114 of a second embodiment of a pipette tip 110.

Identical and functionally identical components and component sections as in FIGS. 1 to 3 are labeled in FIG. 4 with the same reference marks, but in the number range 100 to 199.

The second embodiment of FIG. 4 will be described below only in so far as it differs from the previously described first embodiment, to the description of which express reference is also made for elucidating the following second embodiment.

The second embodiment of FIG. 4 differs from the first embodiment of FIGS. 1 to 3 solely by the fact that a section 111a1 of the outside wall 111a of the pipette tip 110 surrounding the aperture conduit section 130 is configured cylindrically or conically with a small full cone angle of 1° to 5°, in any event in a longitudinal section containing the duct axis K with a straight contour line.

Since as in the first embodiment the rest of the outside wall 111a in the region of the concave axial section 126 is convexly curved with respect to axes of curvature (see FIG. 1) K2 orthogonal to the duct axis K, a transitional region 156 of the outside wall 111a is concavely curved between the cylindrical or conical outside wall section 111a1 and the outside wall 111a in the region of the concave axial section 126 about axes of curvature orthogonal to the duct axis K. The radius of curvature in the transitional region 156 can be very small, such that visually there is created the impression of an encircling edge.

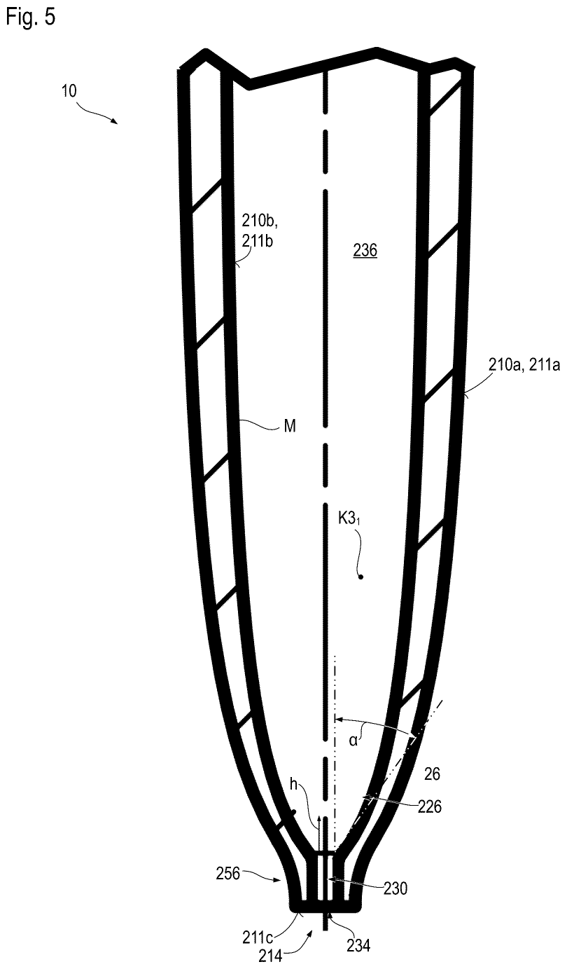

In FIG. 5 there is depicted an enlarged view corresponding to FIGS. 3 and 4 of the metering longitudinal end 214 of a third embodiment of a pipette tip 210.

Identical and functionally identical components and component sections as in FIGS. 1 to 4 are labeled in FIG. 5 with the same reference marks, but in the number range 200 to 299.

The third embodiment of FIG. 5 will be described below only in so far as it differs from the previously described first two embodiments, to the description of which express reference is also made for elucidating the following third embodiment.

The third embodiment differs from the second embodiment only in that the concavely curved transitional region 256 of the outside wall 211a of the pipette tip 210 begins at the metering longitudinal end 214 and in the pipetting aperture-nearer end section of the concave axial section 226 transitions into the previously already described convexly curved region of the outside wall 211a. The contour line of the outside wall 211a is therefore, starting from the metering longitudinal end 214 in the direction towards the coupling longitudinal end 212, initially concavely curved in the axial region of the aperture conduit section 230 and transitions, preferably kink-free, into a convex curvature which the outside wall 211a retains qualitatively with decreasing curvature up to the pipetting aperture-remoter longitudinal end of the concave axial section 226.

The first embodiment has shown in experiments the slightest tendency of wetting by metering fluid dispensed from the receiving space 36.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-16. (canceled)

17. An exchangeable pipette tip, where the pipette tip extends along a duct axis,
Where the duct axis defines an axial direction running along the duct axis, radial directions orthogonal to the duct axis, and a circumferential direction encircling the duct axis,
Where the pipette tip exhibits at its one axial longitudinal end a coupling formation as a coupling longitudinal end configured for coupling with a coupling counter-formation of a pipetting device,
Where the pipette tip exhibits at its longitudinal end which is axially opposite to the coupling longitudinal end a pipetting aperture as a metering longitudinal end, which is connected in a communicating manner with a receiving space configured for receiving fluid which is to be metered,
Where the receiving space of the pipette tip is configured as tapering towards the pipetting aperture,
wherein at least one axial section of the receiving space is concavely configured as a concave axial section in such a way that an inside wall of the pipette tip bordering it radially is configured curved about at least one axis of curvature running transversely to the duct axis.

18. The exchangeable pipette tip according to claim 17, wherein the inside wall is curved in the concave axial section about the at least one axis of curvature running transversely to the duct axis and configured curved about the duct axis as a second axis of curvature.

19. The exchangeable pipette tip according to claim 17, wherein the concave axial section lies in an axial region of the pipette tip which starting from the pipetting aperture extends over 50% of the entire axial extension length of the pipette tip.

20. The exchangeable pipette tip according to claim 17, wherein the concave axial section tapers constantly in the direction towards the pipetting aperture in such a way that along the entire concave axial section it is the case that of two clear cross-sections of the receiving space observed at different axial positions along the duct axis, the cross-sectional area of the cross-section lying nearer to the pipetting aperture is no greater than the cross-sectional area of the cross-section lying further away from the pipetting aperture.

21. The exchangeable pipette tip according to claim 17, wherein for a longitudinal sectional view in at least one longitudinal section plane containing the duct axis it is the case that the curvature of a contour line of the inside wall of the pipette tip radially bordering the concave axial section does not become smaller on approaching the pipetting aperture.

22. The exchangeable pipette tip according to claim 21, wherein for the longitudinal sectional view in the at least one longitudinal section plane containing the duct axis it is the case that the curvature of the contour line of the inside wall of the pipette tip radially bordering the concave axial section becomes greater on approaching the pipetting aperture.

23. The exchangeable pipette tip according to claim 22, wherein the contour line of the inside wall of the pipette tip radially bordering the concave axial section exhibits a hyperbolic course.

24. The exchangeable pipette tip according to claim 17, wherein in an axial region lying between the coupling formation and the concave axial section of the pipette tip there is configured a second axial section of the receiving space whose inside wall bordering it radially differs from the inside wall in the concave axial section with regard to at least one parameter out of inclination relative to the duct axis and curvature about an axis of curvature running transversely to the duct axis.

25. The exchangeable pipette tip according to claim 24, wherein the second axial section is configured in the direction from the coupling longitudinal end to the metering longitudinal end in a tapering manner in such a way that its second clear width orthogonally to the duct axis at its end which lies nearer to the metering longitudinal end is equal to between 40% and 60% of a first clear width parallel to the second clear width at its end which lies nearer to the coupling longitudinal end.

26. The exchangeable pipette tip according to claim 17, wherein there is configured axially between the concave axial section and the pipetting aperture a third section of the receiving space as an aperture conduit section whose inside wall bordering it radially differs from the inside wall in the concave axial section and in the second axial section with regard to at least one parameter out of inclination relative to the duct axis and curvature about an axis of curvature running transversely to the duct axis and clear width orthogonally to the duct axis.

27. The exchangeable pipette tip according to claim 26, wherein the aperture conduit section of the receiving space comprises
i.) A conical section with a cone angle of not more than 6°
and/or
ii.) A bulging section encircling the duct axis in the shape of a concave section or of a convex section with a bulge radius equal at least to ten times the axial length of the bulging section,
and/or
iii.) A cylindrical section.

28. The exchangeable pipette tip according to claim 27, wherein a clear width of the pipetting aperture orthogonal to the duct axis exhibits a dimension of less than 0.38 mm.

29. The exchangeable pipette tip according to claim 26, wherein a clear width of the pipetting aperture orthogonal to the duct axis exhibits a dimension of less than 0.38 mm.

30. The exchangeable pipette tip according to claim 28, wherein a radially outward-facing outside wall of the pipette tip in an extension section overlapping axially with the aperture conduit section
i.) Exhibits when viewed from outside concave curvature about at least one axis of curvature running transversely to the duct axis
and/or
ii.) Exhibits when viewed from outside convex curvature about at least one axis of curvature running transversely to the duct axis
and/or
iii.) Is configured as tapering towards the pipetting aperture
and/or
iv.) Is configured cylindrically.

31. The exchangeable pipette tip according to claim 26, wherein a radially outward-facing outside wall of the pipette tip in an extension section overlapping axially with the aperture conduit section
i.) Exhibits when viewed from outside concave curvature about at least one axis of curvature running transversely to the duct axis
and/or
ii.) Exhibits when viewed from outside convex curvature about at least one axis of curvature running transversely to the duct axis
and/or
iii.) Is configured as tapering towards the pipetting aperture
and/or
iv.) Is configured cylindrically.

32. The exchangeable pipette tip according to claim 17, wherein the axial length of the concave axial section equals between 15% and 60% of the total length of the pipette tip, that the axial length of the second axial section equals between 35% and 70% of the total length of the pipette tip, and that the axial length of the aperture conduit section equals between 0.8% and 3% of the total length of the pipette tip.

33. The exchangeable pipette tip according to claim 17, wherein the coupling formation extends over approximately 15% to 35% of the total length of the pipette tip.

34. A use of an exchangeable pipette tip according to claim 17 for pulse-based dispensing of a metering fluid received together with a working gas in the pipette tip.
